(19) United States
(12) Patent Application Publication
(10) Pub. No.: US 2012/0196121 A1
(43) Pub. Date: Aug. 2, 2012

(54) Leading edge indicator for adhesive tape

(76) Inventor: Norman A. Schwietz, (US)

(21) Appl. No.: 12/931,481

(22) Filed: Feb. 2, 2011

(51) Int. Cl. B32B 7/12

(52) U.S. Cl. 428/354; 428/343

(57) ABSTRACT

An improvement to adhesive tapes in which a colorant is incorporated into one of the constituent layers of the tape allowing easy visual location of the tape's leading edge. The colorant is released upon shearing of the tape to creating a color indicator along the new leading edge.

### CROSS REFERENCE TO RELATED APPLICATIONS

N/A

### STATEMENT CONCERNING FEDERALLY SPONSORED RESEARCH OR DEVELOPMENT

Not Applicable

### REFERENCE TO A MICROFICHE APPENDIX Not Applicable

### BACKGROUND OF THE INVENTION

1. Field of Invention

The present invention generally relates to adhesive tapes and their manufacture.

2. Background of the invention

Adhesive tape wound on rolls have been manufactured and marketed for almost a century. In its simplest configuration adhesive tape comprises an adhesive layer bonded to a support backing layer. The backing layer may be manufactured in a solid color, perhaps the most common examples of this are black colored electrical tapes and silver duct tape. Or the backings may be transparent in combination with an transparent or semi transparent adhesive layer, as in so called clear or magic tape. Adhesive tape is most commonly tightly wound into rolls formed on a spool made of cardboard, plastic or other suitable material. This arrangement allows the tape to be efficiently manufactured, stored and dispensed. It also allows the tape to be mounted for use in a dispenser where the tape is capable of being dispensed by pulling on its leading edge and unreeling a strip of desired length from the roll. Once the desired amount has been unreeled, it can be separated from the balance of the roll by cutting or shearing the end of the strip on a serrated edge lip of the dispenser. The lip also eases use of the tape by providing a surface to for a short length of tape to adhere to, holding the tape in readiness for use. Alternatively, the desired length of tape can be dispensed directly from the roll itself with the desired being separated from the rest of the roll by cutting the tape with a scissors, knife or other cutting instrument.

Tapes are often manufactured in such a way to incorporate a short non adhesive tab or swatch in a contrasting color, colors or pattern attached to the forward end of the roll to initially indicate the location of leading edge of the tape and to assist in the initial positioning of the tape into the dispenser for use.

One fundamental difficulty or nuisance inherent with adhesive tapes is the difficulty in distinguishing the location of the leading edge on the roll after the first use. The uniform color of the backing and the tightness of the tape on the roll itself, a product of the manufacturing process contribute to this problem. This difficulty can occur even if the tape is dispenser mounted as the leading edge may become unattached from the dispenser and attach itself to the still wound balance of the roll. Solutions to this problem, like doubling a short section of the leading edge of the adhesive side of the tape back against a similar length following section or adhering a short section of the adhesive side of the tape to the outer surface of the backing, are imperfect. They require that the operation be performed each time the tape is dispensed. If the adhesive component of the tape is highly sticky this can lead to twists and tangles and the tape adhering to itself causing wastage. This solution is also of limited practicality in applications or settings with high volume tape usage.

### SUMMARY OF THE INVENTION

The invention as fully described and claimed below allows easy location of the leading edge of adhesive tape rolls through use of an indicator in a color which contrasts with the color if any of the backing layer of the tape itself. The indicator can be incorporated into any of the constituent components of the tape during manufacture. The indicator is released as the tape is cut or sheared from the roll separating the length of tape to be utilized from the roll and creating a new leading edge.

### BRIEF DESCRIPTION OF THE DRAWINGS

### Key to Drawings

1—Backing layer

2—Binder layer

3—Adhesive Layer

5—Colorant/Indicator

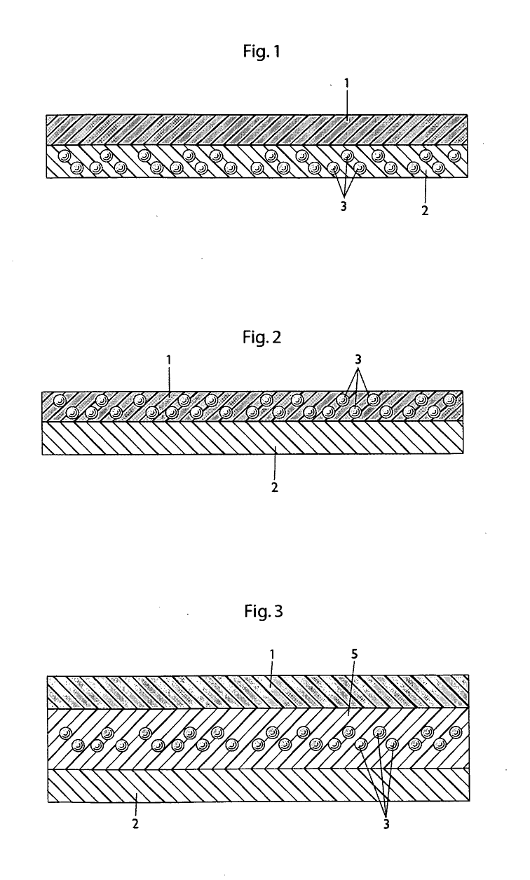

FIG. 1 is a cross sectional view of a variant of the tape with its constituent parts consisting of a backing layer (1) an adhesive layer (2) with the colorant/indicator (3) incorporated into the adhesive layer.

FIG. 2 is a cross sectional view of a variant of the tape with its constituent parts consisting of a backing layer (1) an adhesive layer (2) with the colorant/indicator (3) incorporated into the backing layer.

FIG. 3. is a cross sectional view of the tape showing its constituent layers consisting of a backing layer (1), an adhesive layer (2) a binder layer (5) and with the colorant/indicator (3) incorporated into the binder layer.

### DESCRIPTION OF THE PREFERRED EMBODIMENT OF THE INVENTION

In the preferred embodiment of the invention the ncorporation of a colorant to adhesive tape during the tape's manufacturing process in a color which contrasts with the color of the backing layer of the tape. The colorant will be of a type such that the contrasting color becomes fully visible or apparent at the leading edge of the tape each time a new leading edge of the tape roll is created by detachment of a strip of tape from the roll. The cutting or shearing of the tape physically releases or actives the colorant or color forming substance. The colorant can be freely dispersed or in a micro encapsulated and be added to any of the component layers which comprise the tape. The choice of specific formulations, physical packaging if any and incorporation of the colorant into the adhesive tape during the manufacturing process is well known to those skilled in the art without departing from the scope and spirit of the invention. The invention includes the description using the name of the component without a part of or all of the limitations on the configuration and the material etc.

The present invention is applicable to any type of adhesive tape.

I claim:

1. An adhesive tape comprising:
a. a support layer;
b. an adhesive layer;
c. said adhesive tape incorporating a color forming substance which is released upon shearing or cutting of the tape.

2. An adhesive tape as described in claim 1 wherein the color forming substance is incorporated into the support layer of the tape.

3. An adhesive tape as described in claim 1 wherein the color forming substance is incorporated into the adhesive layer of the tape.

4. An adhesive tape comprising a support or backing layer one side of which is bonded to a strong flexible binder matrix containing an encapsulated color forming substance, said binder matrix being coated with a pressure sensitive adhesive layer, said color forming substance being released upon shearing or cutting of the tape.

5. An adhesive tape comprising in combination a sheet backing material to one face of which is firmly adherently bonded a smooth, uniform coating of normally tacky and pressure sensitive adhesive wherein the improvement comprises the disbursement of micro capsules containing a color forming substance within one or more of the constituent layers of the tape, said color forming substance being released upon shearing or cutting of the tape.

6. An adhesive tape as described any of the preceding claims in which the color forming substance is activated upon contact with air.
